(19) United States
(12) Patent Application Publication
(10) Pub. No.: US 2012/0293854 A1
(43) Pub. Date: Nov. 22, 2012

(54) NON-LINEAR MATERIALS AND RELATED DEVICES

(76) Inventors: Nikolay Ivanovich Zheludev, Southampton (GB); Eric Plum, Southampton (GB); Jun-Yu Ou, Southampton (GB); Kevin Macdonald, Southampton (GB); Andrey Nikolaenko, Southampton (GB); Jianfa Zhang, Southampton (GN); Mengxin Ren, Southampton (GB); Baohua Jia, Victoria (AU)

(21) Appl. No.: 13/473,038

(22) Filed: May 16, 2012

(30) Foreign Application Priority Data
May 16, 2011 (GB) 1108139.5

(51) Int. Cl. G02F 1/35

(52) U.S. Cl. 359/244; 359/326

(57) ABSTRACT

A non-linear optical device comprising a non-linear element made of a plasmonic material with a periodic structure having a period smaller than the wavelength of a non-linear process intrinsic to the plasmonic material. The plasmonic material is implemented as a gold film which is structured with a periodic array of asymmetric split ring slits. The metamaterial framework of the plasmonic material itself is used as the source of a strong and fast non-linearity. The cubic non-linear response is resonantly enhanced through the effect of the metamaterial structuring by more than two orders of magnitude and its sign and magnitude can be controlled by varying the metamaterial pattern.

### BACKGROUND OF THE INVENTION

This invention relates to non-linear materials and non-linear devices incorporating such materials.

Conventional non-linear media are unlikely to be able to provide the speed and strength of non-linear effect that are needed by next generation data processing circuits and all-optical switches. To overcome this bottleneck, metamaterials are being researched. A non-linear metamaterial is an artificial medium structured on a size scale smaller than the wavelength of the external stimulus which induces the non-linear process, wherein the sub-wavelength structure serves to enhance the non-linear process. A layer of a conventional non-linear material such as semiconductor or carbon nanotubes has been combined with a layer of metal which support surface plasmon polaritons and has been meta-structured to enhance non-linearities in the non-linear material.

References 1 and 2 disclose a periodically structured two-dimensional grid-like structure, referred to as a fishnet in these references, in which an amorphous silicon layer is sandwiched between two silver layers, i.e. Ag-αSi—Ag. The structured silver layer supports plasmons and localizes the electromagnetic field in the amorphous silicon layer to enhance non-linear effects therein. In these structures, the speed of the non-linear response depends on the thermalization of hot electrons in semiconductors. In Reference 1 the signal modulation was up to about 30% and the response time about 750 fs. In Reference 2 the signal modulation was about 20% and the response time about 600 fs.

Reference 3 discloses a carbon nanotube (CNT) layer with a structured gold layer structured with a two-dimensional array of square-profile split ring holes. The structured gold layer supports plasmons and localizes the electromagnetic field in the carbon nanotube layer to enhance non-linear effects therein. The speed of the non-linear response depends on the exciton dynamics [3]. The signal modulation was about 10% and the response time is postulated to be less than about 600 fs.

Reference 4 discloses a non-linear metamaterial which does not have the hybrid structure of the kind shared by References 1, 2 and 3. Rather, the metamaterial is formed by the meta-structured plasmonic metal itself. Gold rods are attached vertically to a glass substrate and embedded in an alumina matrix, wherein the glass substrate and alumina are essentially inert in so far as the exploited non-linear process is concerned. The gold rods have a diameter of 20 nm and a length of 400 nm and self assemble standing up substantially vertically on the glass with a range of lateral separations, analogous to blades of grass on a lawn. The average lateral separation, i.e. center-to-center spacing, between the rods is 70 nm. The exploited non-linear process is based on surface plasmons in the gold nanorods. The speed of the non-linear response depends on the thermalization of hot electrons in the gold. The signal modulation was about 80% and the response time postulated to be of the order of 600 fs.

### SUMMARY OF THE INVENTION

We have demonstrated that the metal of the metamaterial framework itself can be used as the source of an even faster non-linearity than has ever been achieved with a metal metamaterial on a semiconductor or CNT. In particular, the cubic non-linear response of the non-linearity in the metal can be resonantly enhanced through metamaterial structuring by more than two orders of magnitude and its sign and magnitude can be controlled by varying the metamaterial pattern. This gigantic engineered non-linearity in structured metal, which is at least one order of magnitude faster than the fastest non-linearities in metamaterials reported so far [1, 4], can be engaged to control light with light on the femtosecond time scale at an average power level of only a few milliwatts.

The frequency at which this enhancement occurs may be controlled by varying the design of the metamaterial, and in a certain frequency range the nanostructuring can reverse the sign of the non-linearity.

Devices embodying the invention can be based on direct multi-photon absorption, in particular a two-photon absorption, in the metal which is an inherently much faster process than that exploited by hybrid metal-semiconductor or metal-CNT metamaterials. Other devices embodying the invention can be based on saturable absorption or four-wave mixing.

Extremely fast response times under 100 fs can be achieved with the engineered optical non-linearity through the nanoscale periodic sub-wavelength (metamaterial) patterning of the thin metal film.

It is emphasized that this is a non-hybrid effect intrinsic to the patterned metal itself which occurs in the absence of any other optically non-linear medium. The presence of another non-linear material, such as a semiconductor, is therefore not required and will be omitted in most cases unless required for an unrelated reason, e.g. if the metamaterial element of the overall device is part of a semiconductor waveguide structure. In many embodiments, the metal will however need to be supported by a suitable substrate, which may be part of a device of which the metamaterial forms a part. For example, the metamaterial may be formed on and supported by a surface of a waveguide, such as the end facet of an optical fiber or planar waveguide, or a side surface of a rib waveguide made of any conventional material such as a semiconductor or lithium niobate or related compounds.

The flexibility of the metastructuring of the metal allows a resonantly enhanced, ultrafast non-linear optical response to be achieved at any desired wavelength across the visible to near-infrared wavelength range. Compared with prior art hybrid metamaterials, the proposed materials and related devices should be simpler and hence cheaper to produce. This is because the proposed medium can be fabricated solely of one material, i.e. one metal, in particular one pure metal. By contrast, prior art hybrid structures impose additional constraints both physical and practical, because of the need to combine a metal with a semiconductor or other non-linear medium, and to structure this hybrid structure through suitable etching or other processing. Factors such as chemical compatibility and mutual adhesion must be considered as well as choosing an etching process for structuring the metal which is compatible with the semiconductor or other non-linear medium.

The ability to engineer such a gigantic optical non-linearity in a structure of sub-wavelength thickness is useful for the laser and integrated photonic device industries. The metamaterial is suitable for optical limiting and all-optical switching with sub-100 fs response times. Devices made of the metamaterial should therefore support data processing in the 10 THz bit rate domain. Moreover, the metamaterial shows a strong and fast saturable absorption effect so can be used for Q-switching and mode-locking, e.g. for mode locked femtosecond lasers.

As described below, we have fabricated and experimentally demonstrated a specific example of an asymmetric split-ring metamaterial pattern in gold. The invention can certainly also be exemplified in silver, aluminum and copper. In principle, any surface plasmonic material should work which will include other metals and some non-metals, such as transparent conductive oxides (for infrared applications) graphene and semiconductors. A suitable conductive oxide is indium tin oxide (ITO). Suitable semiconductors are silicon carbide and gallium arsenide. The invention can also certainly be exemplified with a wide range of periodic metamaterial pattern geometries including circular rings, oval rings, fishnet grids and so forth. Most current metastructures are based on planar or two-dimensional (2D) patterning. As technology progresses it is expected that techniques for fabricating three-dimensional (3D) metastructures will be developed, and the invention can also be applied to such 3D metastructures.

According to one aspect of the invention there is provided a non-linear optical device comprising a non-linear element made of a plasmonic material with a periodic structure having a period shorter than the wavelength of a non-linear process intrinsic to the plasmonic material.

According to an alternative definition, the invention provides a non-linear optical device comprising a non-linear element made of a plasmonic (metal or non-metal) material, wherein the non-linear element has a range of operating wavelengths defined by the wavelength of a non-linear process intrinsic to the plasmonic material, and wherein the plasmonic material is structured with a period which is shorter than the operating wavelengths.

It will be understood that the non-linear process will typically have a range of wavelengths over which it is active, so that the periodicity of the plasmonic material needs to be smaller than at least a part of that range.

In some embodiments, the non-linear process is a direct two-photon absorption process in the plasmonic material. The two-photon absorption process preferably has a response time of less than 100 fs as well as a transmission modulation of at least 25%. The two-photon absorption process may involve two photons of equal energy, which may be part of the same beam or different beams, or two photons of different energies, which may be part of the same beam or different beams. Alternatively, three-photon, four-photon or other higher order photon absorption processes in the plasmonic material could be used. In other embodiments, the non-linear process is a saturable absorption in the non-linear element. In still further embodiments, the non-linear process is four-wave mixing in the non-linear element.

The plasmonic material will typically be a metal, but may be a non-metal capable of supporting a surface plasmon. The metal is preferably gold, silver, aluminum, copper, or an alloy including one or more of these metals and a further metal or metals, or an alloy consisting only of two or more of these metals.

The non-linear element may be fabricated as a periodically structured layer of the plasmonic material which is supported on a substrate or another part of the device, for example a waveguide. The substrate will typically be made of a material that has substantially negligible non-linearity in the operating wavelength range compared to the plasmonic material. In other cases, the periodically structured layer is self supporting. The structuring is preferably periodic in two-dimensions. Three-dimensional or one-dimensional periodicity could also be used. In the case of 2D or 3D structuring, the period in each of the two- or three-dimensions is preferably equal.

The device may include a waveguide having a waveguiding channel, wherein the non-linear element is arranged integrally within or on the waveguiding channel. For example, the non-linear element could be a structured metal layer deposited on the end face of an optical fiber or the end face of a solid-state waveguide, such as a semiconductor heterostructure waveguide, or a lithium niobate or tantalate waveguide. In other examples, the non-linear element could be formed on side surfaces of solid-state waveguides (e.g. on the upwardly facing side surface of a rib waveguide) or side surfaces of optical fibers (e.g. on the flat lateral surface of a D-shaped optical fiber). The device may also include several waveguides, where the non-linear element may be arranged at the interface between two waveguides or form the interface between two waveguides.

The invention also provides a method of modulating an optical signal comprising making an optical beam of a particular wavelength incident on a non-linear element made of a plasmonic material that has a non-linear process active at that wavelength and which is periodically structured with a period which is shorter than the wavelength of the incident optical beam, so that the non-linear process modulates the incident optical beam. The modulation may be self induced by the optical signal or induced by an actuation of the plasmonic material with a control signal, which may be a further optical signal, or another signal, for example electronic, which excites the plasmonic material.

The invention also provides a method of modulating a first optical signal with a second optical signal comprising making the first and second optical signals of respective first and second wavelengths co-incident as first and second optical beams on an area of a non-linear element made of a plasmonic material that has a non-linear process active at the first or second wavelengths, or a sum or difference of the first and second wavelengths, and which is periodically structured with a period which is shorter than the first and second wavelengths, so that the non-linear process modulates the first optical signal under action of the second optical signal.

### BRIEF DESCRIPTION OF THE DRAWINGS

This invention will now be further described, by way of example only, with reference to the accompanying drawings.

FIG. 1 shows various aspects of a metamaterial exemplifying the invention.

FIG. 2 shows various linear and non-linear optical properties of the example metamaterial.

FIG. 3 shows the magnitude (FIG. 3A) and speed (FIG. 3B) of the non-linearity in the example plasmonic metamaterial:

FIG. 4 shows how the wavelength of the resonant behavior of the non-linearity of the example plasmonic metamaterial can be tuned by varying the periodicity, i.e. unit cell size, of the periodic structure of the metamaterial.

FIG. 5 is a graph showing average power of light transmitted through the example metamaterial Pₒᵤₜ as a function of average incident power Pᵢₙ, where the transmitted power Pₒᵤₜ is normalized to the low-intensity (linear) transmission Tₗᵢₙₑₐᵣ.

FIG. 6A is a perspective schematic drawing of an example optical limiter.

FIG. 6B is a schematic cross-section of another example optical limiter.

FIG. 6C is a schematic cross-section of a further example optical limiter.

FIG. 7 is a schematic drawing of an example optical gating element.

FIG. 8 is a schematic drawing of an example integration of multiple gating elements.

FIG. 9A is a schematic drawing of an example passive Q-switched or mode-locked laser.

FIG. 9B is a schematic drawing of another example passive Q-switched or mode-locked laser.

FIG. 10A is a schematic drawing of an example active Q-switched or mode-locked laser.

FIG. 10B is a schematic drawing of another example active Q-switched or mode-locked laser.

FIG. 11A is a schematic drawing of an example passive Q-switched or mode-locked ring laser.

FIG. 11B is a schematic drawing of an example active Q-switched or mode-locked ring laser.

FIG. 12A is a schematic drawing of an example passive non-linear mirror with a non-normally incident beam.

FIG. 12B is a schematic drawing of an example passive non-linear mirror with a normally incident beam.

FIG. 13A is a schematic drawing of an example active non-linear mirror with a non-normally incident signal beam.

FIG. 13B is a schematic drawing of another example active non-linear mirror with a non-normally incident signal beam.

FIG. 13C is a schematic drawing of an example passive non-linear mirror with a normally incident signal beam.

FIG. 14 is a schematic drawing of an example integration of a passive non-linear element embodying the invention in a planar waveguide.

FIG. 15A is a schematic drawing of an example integration of an active non-linear element embodying the invention in a planar waveguide.

FIG. 15B is a schematic drawing of another example integration of an active non-linear element embodying the invention in a planar waveguide.

FIG. 16 is a schematic drawing of an example four-wave mixing device and phase-conjugated mirror.

FIG. 17A is a schematic drawing of another example four-wave mixing device and phase-conjugated mirror.

FIG. 17B is a schematic drawing of a further example four-wave mixing device and phase-conjugated mirror.

FIG. 18A-18G are schematic drawings of alternative unit cell forms for the metamaterial structure.

### DETAILED DESCRIPTION

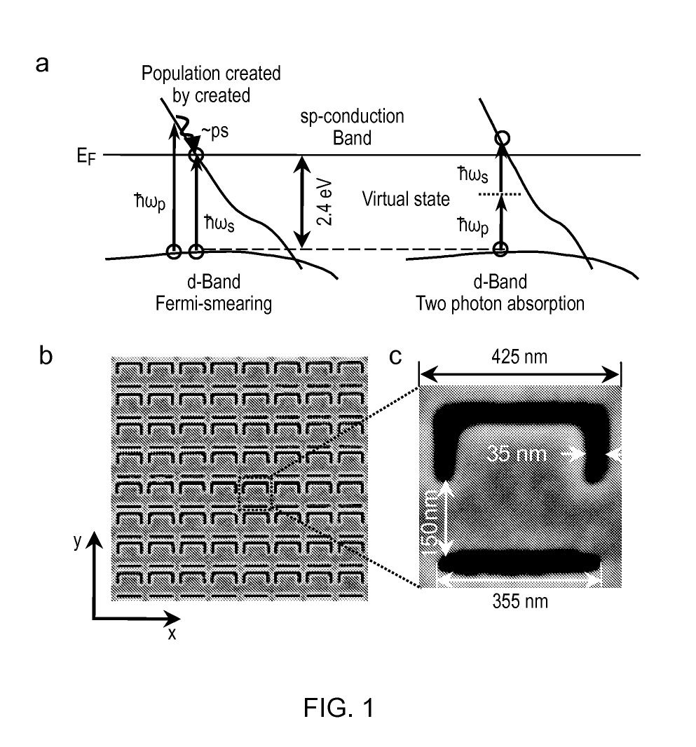

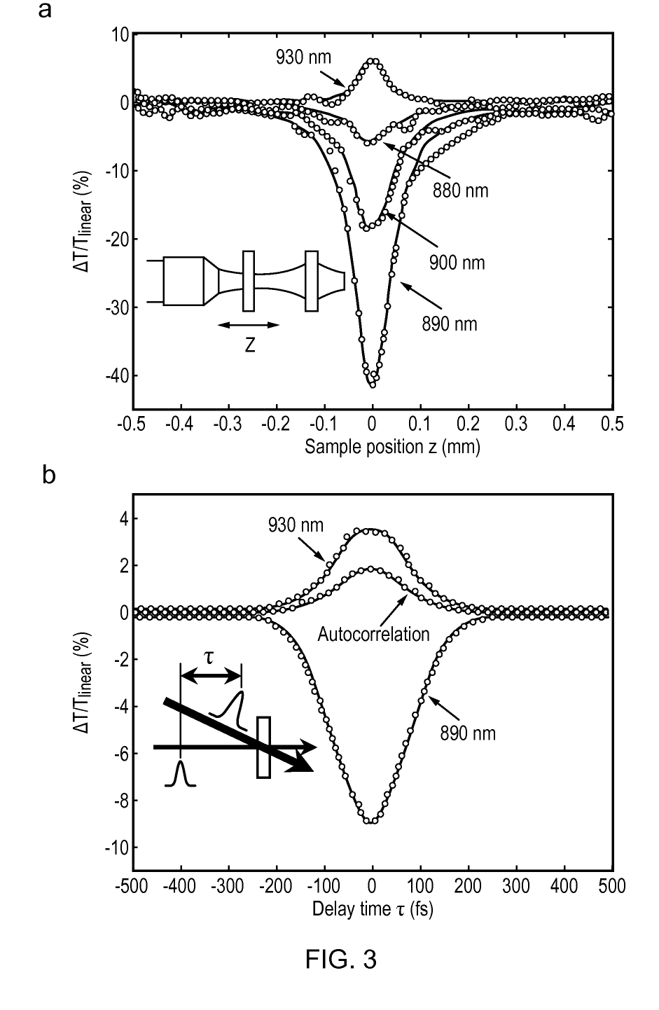

FIG. 1(a) shows a comparison between ‘Fermi smearing’ and two-photon non-linear responses in gold. The dominant mechanism of gold's cubic non-linearity is the so-called ‘Fermi-smearing’ process in which light absorption at a frequency ωₚ leads to a non-equilibrium redistribution of electrons near the Fermi level (E_{F}). When probed at ωₛ this Fermi-smearing has most impact on transitions between the d-band states lying ΔE=2.4 eV below the Fermi level to states above the Fermi level, as illustrated in the left-hand part of FIG. 1(a). Fermi-smearing leads to a very strong cubic optical non-linearity and non-linear absorption (β˜10⁻⁵ m/W) peaking at a wavelength of about 516 nm. However this non-linearity is relatively slow as it depends on the thermalization of the hot electron ensemble, which occurs over a period of several picoseconds. To engineer a much faster non-linear medium, we engage the less efficient but ‘instantaneous’ non-linear process of direct non-resonant two-photon absorption between the d and sp states of the metal, as illustrated in the right-hand part of FIG. 1(a). Direct two-photon absorption takes place without a real intermediate level as there are no empty states in the Fermi sea. It occurs through a virtual state when the energy of two incident photons is combined to bridge a gap that cannot be bridged by individual photons: [symbol] ωₚ+ [symbol] ωₛ>ΔE. When characterized in a pump-probe experiment (FIG. 3b described below), the direct two-photon absorption non-linearity is shown to have a very fast response time because it requires both the pump ωₚ and the probe ωₛ photons to be present simultaneously, and no slow decay carrier recombination is involved. In fact the uncertainty principle prescribes a finite lifetime for the virtual level, and thus a finite non-linearity response time of order [symbol] /δE<1 fs, where δE≈ΔE/2 is the energy difference between the virtual level and the nearest real state. Even with this limitation, this is an extremely fast degenerate cubic optical non-linearity giving rise to a non-linear absorption coefficient of order 10⁻⁸ m/W.

FIG. 1(b) is a scanning electron micrograph of the example nanostructured gold film which is based on an asymmetric split ring structure as has been described elsewhere [5].

FIG. 1(c) is an enlarged detail of a single meta-molecule of the pattern of FIG. 1(b).

The metamaterial has a giant plasmon-mediated femtosecond non-linearity.

The periodic split ring metamaterial patterning structure acts to enhance the efficiency of the direct two-photon non-linearity by resonant plasmon-mediated local field enhancement, supporting a plasmonic closed mode (Fano-like) excitation.

The split ring pattern is chosen for its small resonant mode volume of about 10⁻³ λ³ (where λ is wavelength) located mostly within the grooves of the structure, leading to a very high field concentration at the edges of the grooves. Other patterns could also be used, such as circular or oval rings or arrays of holes, such as in the fishnet structure of the prior art hybrid metamaterial structures. In the example, the metamaterial has a lattice parameter of 425 nm which provides a plasmonic resonance at λ=890 nm where the non-linear response of gold is dominated by direct two-photon absorption. The nanostructure consists of a periodic array of asymmetric split ring slits cut through a 50 nm thick gold film thermally evaporated on a quartz substrate. The overall area of the pattern was 100 μm×100 μm. The pattern was manufactured by focused ion beam milling.

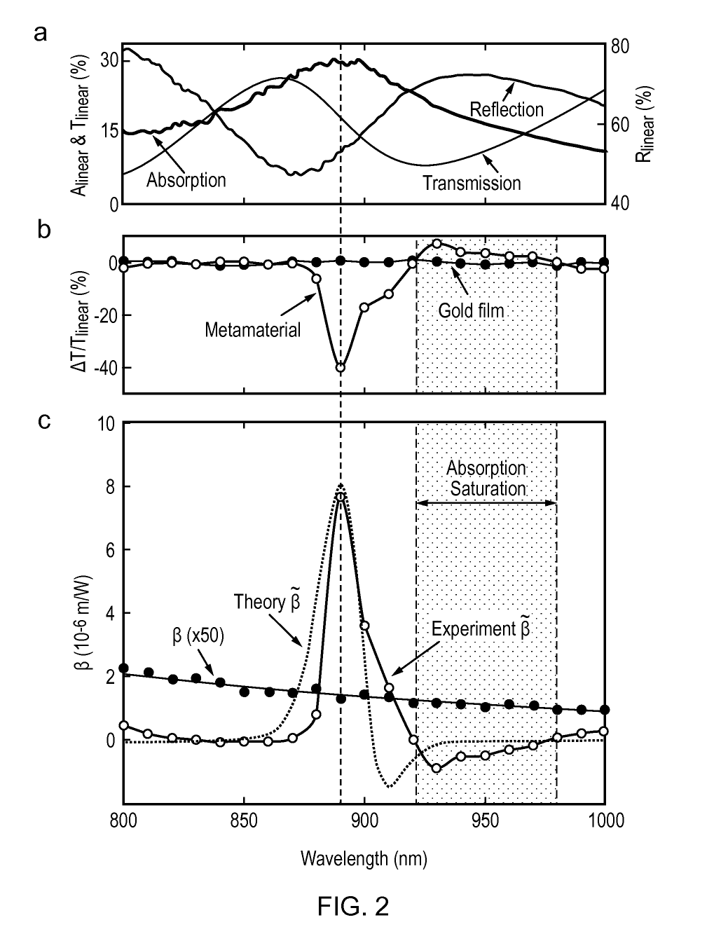

FIGS. 2(a), 2(b) and 2(c) show various linear and non-linear optical properties of the example metamaterial.

FIG. 2(a) shows linear absorption, transmission and reflection spectra of the metamaterial between 800 nm and 1000 nm, i.e. around its plasmonic resonance at 890 nm. The incident light is polarized in the y-direction.

FIG. 2(b) shows the non-linear transmission change ΔT/Tₗᵢₙₑₐᵣ at an illumination intensity of 2.3 GW/cm² for the example metamaterial and also for an unstructured gold reference film. While the 50 nm thick unstructured gold film shows only very small changes of transmissivity at this intensity, the structured metamaterial film exhibits a much more pronounced response. A sharp decrease of transmissivity is seen around the resonance at 890 nm. At longer wavelengths in the range from λ=920 nm to λ=980 nm transmissivity increases indicating absorption saturation.

FIG. 2(c) shows the example metamaterial's experimentally measured and theoretically evaluated effective two-photon absorption coefficient \tilde{β} compared to that of an unstructured gold film β (50× enlarged). The additionally indicated wavelength range between 920 nm and 980 nm is the range over which absorption saturation occurs. As can be seen, the metamaterial shows an incredibly strong resonant enhancement of the two-photon absorption coefficient \tilde{β} around the resonance at 890 nm as well as significant levels of negative values of the non-linear absorption coefficient \tilde{β} between 920 nm and 980 nm where absorption saturation is occurring. The two-photon absorption coefficient β of the continuous gold film (shown 50× enlarged) exhibits monotonic dispersion in the wavelength range between 800 and 1000 nm. In contrast, the non-linearity of the nanostructured gold film has a dramatic resonance at λ=890 nm (coinciding with a linear absorption peak) where its non-linearity reaches β=7.7×10⁻⁶ m/W. This is a 300 times enhancement in non-linearity over the level for unstructured gold at the same wavelength. Interestingly, in the wavelength range between 920 nm and 980 nm the nanostructured film shows absorption saturation (bleaching) instead of the non-linear absorption characteristic of unstructured gold. This absorption saturation corresponds to negative values of β, reaching −9.0×10⁻⁷ m/W at 930 nm.

FIG. 3(a) shows the non-linear transmission change ΔT/Tₗᵢₙₑₐᵣ as the illumination intensity incident on the example metamaterial is varied by varying the position of the metamaterial relative to the focus of a laser. The method is referred to as an open aperture Z-scan technique [6]. The measurements used a femtosecond frequency-tunable Ti:sapphire laser having a pulse duration of 115 fs and a repetition rate of 80 MHz. The laser had an average laser power level of 3 mW. The example gold film's transmission was recorded while scanning the sample through the 6 μm focus of the laser beam, which corresponds to a peak pulse intensity at the focus of a few GW/cm² for the 3 mW beam power level. The laser beam was polarized perpendicular to the split in the metamaterial ring resonators (the y-direction as defined in FIG. 1b). The measurements were performed at four different wavelengths in the proximity of the metamaterial's plasmonic resonance at λ=890 nm, namely at 880 nm, 890 nm (peak resonance), 900 nm and 930 nm. The data points are shown by the circles and the solid lines are analytical fits to the data points. The non-linearity of the film is clearly seen.

The effects of two-photon absorption and non-linear bleaching on the light intensity I within a non-linear medium are conventionally described by the expression:

$$- \frac{d I}{d z} = α I + β {I}^{2} + …$$

where z is the propagation distance, and
α and β are respectively the linear and non-linear absorption coefficients.

In the present case, values of α and β can be derived from absorption and Z-scan measurements if one reasonably assumes that higher-order processes are insignificant and considers the nanostructured gold film as an effectively continuous medium (the latter being justified because a metamaterial with periodic sub-wavelength patterning does not diffract or scatter light at normal incidence).

The dramatic increase in the efficiency of two-photon absorption can be explained as a consequence of local field enhancement in the metamaterial. Indeed, assuming that the complex cubic susceptibility of gold is dominated by its imaginary part, the metamaterial's effective two-photon absorption coefficient \tilde{β} resulting from local filed enhancement can be calculated from the measured two-photon absorption coefficient of unstructured gold β and the knowledge of the local field distribution in the metamaterial \tilde{E} as follows:

$$\tilde{β} = Re \{ \frac{\int {\tilde{E}}^{2} {\vert \tilde{E} \vert}^{2} d v}{{E}^{2} {\vert E \vert}^{2} \tilde{V}} \} \frac{{n}^{2}}{{\tilde{n}}^{2}} β , \qquad ( 1 )$$

where \tilde{V} is the gold volume of a single meta-molecule, ñ the metamaterial's effective refractive index, n is the refractive index of bulk gold and E is the electric field of the incident wave as it would be distributed in an unstructured gold layer.

We evaluated integral (1) numerically using a full three-dimensional Maxwell solver to calculate the electric field distribution \tilde{E} in the metamaterial. ñ was also retrieved from these calculations using the S-parameter method [7]. As FIG. 2c shows, the field enhancement model describes all of characteristic features of the metamaterial's two-photon absorption spectral dispersion, including the resonant enhancement of non-linear absorption and non-linear bleaching (absorption saturation) at longer wavelengths. This bleaching effect is described by negative values of \tilde{β} and may be traced to a peculiar phase relation between the incident and local fields in the asymmetric split ring metamaterial pattern that produces negative values of the field enhancement factor.

FIG. 3(b) shows time-resolved pump-probe scans showing non-linear absorption and bleaching dynamics for the example metamaterial at wavelengths of 890 nm and 930 nm alongside a reference second-harmonic autocorrelation envelope for the pulses. The pump-probe scans were carried out with non-collinear (15°) degenerate pump-probe transient spectroscopy with pulses spatially overlapped at a ˜30 μm diameter focal spot. The pump and probe beams had fluences of ˜70 μJ/cm² and ˜1.6 μJ/cm² respectively and both were polarized, as in the Z-scan experiment, perpendicular to the split in the metamaterial rings. Measurements of pump-induced non-linear absorption and bleaching revealed no asymmetric temporal dynamics, rather a symmetric effect with respect to zero delay. The results indicate that the non-linear response time is substantially shorter than the 115 fs duration of the pump and probe pulses.

The results shown in FIGS. 3(a) and 3(b) demonstrate that the non-linear response in the example metamaterial is both incredibly strong and extremely fast.

Although the underlying two-photon absorption non-linearity is extremely fast and controlled by the sub-fs lifetime of the virtual state, the resonant non-linearity enhancement must take a toll on the speed of the metamaterial's non-linear response. If the two-photon non-linearity is enhanced by a resonant plasmonic response with a width δv=2.7×10¹³ s⁻¹, the uncertainty argument δT×δv≧1 dictates that its relaxation time will be limited to δT=1/δv˜40 fs, which still is a very fast response that cannot be resolved with the 115 fs optical pulses used in our experiments.

The resonant enhancement of the gold film's third order non-linearity resulting from nanostructuring is a narrow-band effect. However, the spectral localization of this ‘engineered’ resonance can be controlled by adjusting metamaterial design, for instance by simply varying the dimensions of the meta-molecule.

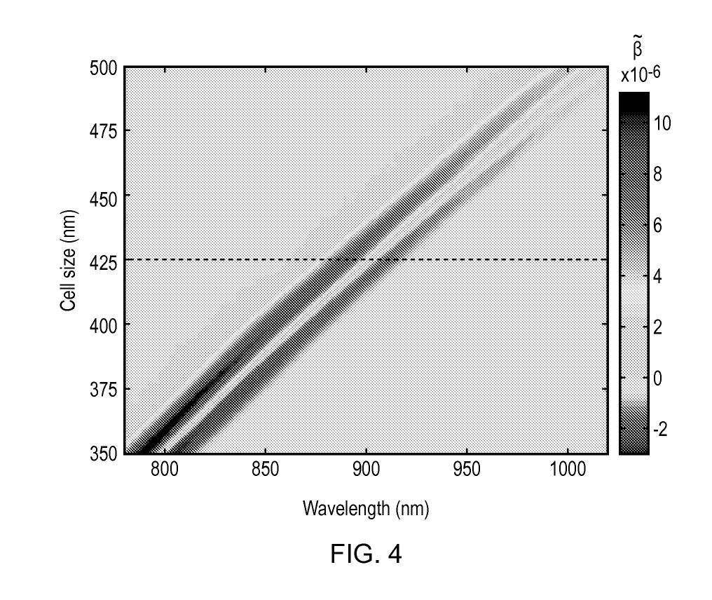

FIG. 4 shows, based on equation (1), how the wavelength of the resonant behavior of the non-linearity of the example plasmonic metamaterial can be tuned by varying the periodicity, i.e. unit cell size, of the periodic structure of the metamaterial. The graph shows the theoretically predicted spectral dependence of the two-photon absorption coefficient \tilde{β} as a function of the unit cell size. The results are for a slit width of 35 nm in all cases. The horizontal dashed line at a cell size of 425 nm indicates the cell size of the specific example. For a given cell size, the width of the positive resonance in \tilde{β} is roughly 10-30 nm and the width of the negative resonance in \tilde{β}, which is at higher wavelengths than the positive resonance, is approximately 5-20 nm.

At the long wavelength end of the range shown in the graph the plasmonic local field enhancement factor remains strong but the underlying value of the unstructured gold non-linearity decreases rapidly as the combined energy of the two photons approaches the 2.4 eV edge of the interband transitions between the d and sp states.

At the plasmonic resonance the two-photon absorption coefficient \tilde{β} is about 7.7×10⁻⁶ m/W, corresponding to a third-order non-linear susceptibility of 1.5×10⁻¹⁵ m²/V². We believe this to be the largest ultrafast frequency degenerate cubic optical non-linearity with a relaxation time less than 100 fs observed to date. For example, it is seven orders of magnitude stronger than the two-photon absorption non-linearity of the classic non-linear reference medium CS₂ [8].

To assess practical and data processing applications it is instructive to compare the resonance switching performance of the gold nanostructured metamaterial with other recently developed engineered non-linear metamaterials in terms of modulation depth, speed of response and required excitation fluence.
The example gold metamaterial reported here shows at least 40% transmission modulation with a response time considerably shorter than 100 fs (estimated to be 40 fs) at an excitation fluence of 270 μJ/cm².
A prior art metamaterial exploiting the non-linearity of α-silicon [1] at a similar 300 μJ/cm² excitation level shows a somewhat smaller level of response of 30% with a response time of >750 fs which is at least seven times slower.
Another prior art metamaterial that exploits non-linearities in carbon nanotubes [3] offers ˜10% modulation at lower fluence (40 μJ/cm²) with a relatively slow response time (estimated ˜600 fs).
Another prior art metamaterial based on plasmonic nanorod metamaterial [4] exhibits a large response (up to 80%) but one that is least one order of magnitude slower and requires fluences that are more than one order of magnitude higher (a few μJ/cm²).

In SESAMs (semiconductor saturable absorber mirrors), which is a popular medium for laser mode-locking, a relatively low saturation fluence (˜10 μJ/cm²) may be achieved by changing dopants or adjusting parameters of the nanostructure fabrication process, but it is difficult to simultaneously achieve a femtosecond-timescale response as inevitable interband trapping and recombination processes limit the response time to the picosecond to nanosecond range.

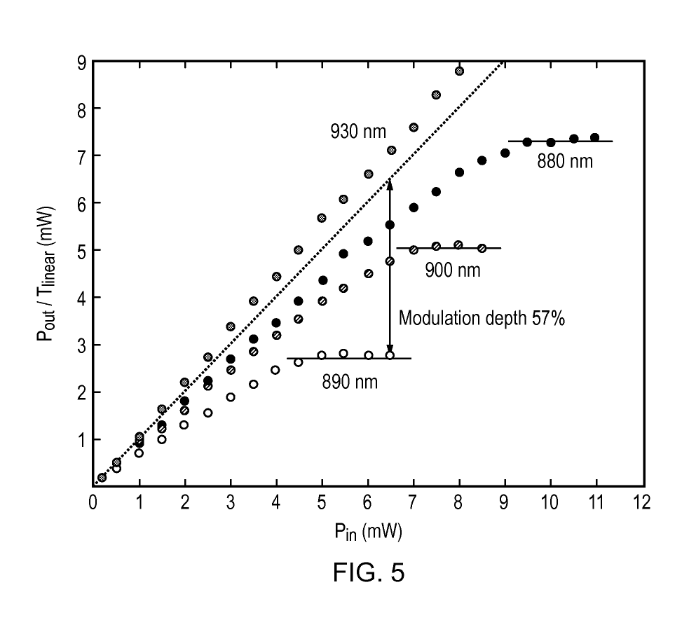

FIG. 5 is a graph showing average power of light transmitted through the example metamaterial Pₒᵤₜ as a function of average incident power Pᵢₙ, where the transmitted power Pₒᵤₜ is normalized to the low-intensity (linear) transmission Tₗᵢₙₑₐᵣ. The dashed line corresponds to a strictly linear response. The sub-linear curves are the results for wavelengths of 880, 890 and 900 nm show regimes of optical limiting. The maximum modulation depth is for the 890 nm results, which is closest to the peak of the plasmonic resonance, and is 57%. The hyper-linear curve is the results for 930 nm which is the regime of absorption saturation (bleaching).

The example metamaterial is therefore suitable for use in all-optical switching devices and ultrafast optical limiting devices (sub-linear response domain) as well as Q-switching and mode-locking devices (supra-linear response domain).

The magnitude and speed of the non-linearity will permit optical data processing in the >10 THz bit rate domain. Moreover, the saturable absorption may be used for Q-switching and mode-locking. In the example metamaterial studied here the resonant insertion loss is about −7.5 dB. However, we envisage that this can be reduced by optimizing the design and using other less lossy plasmonic metals, in particular silver, as the metamaterial framework.

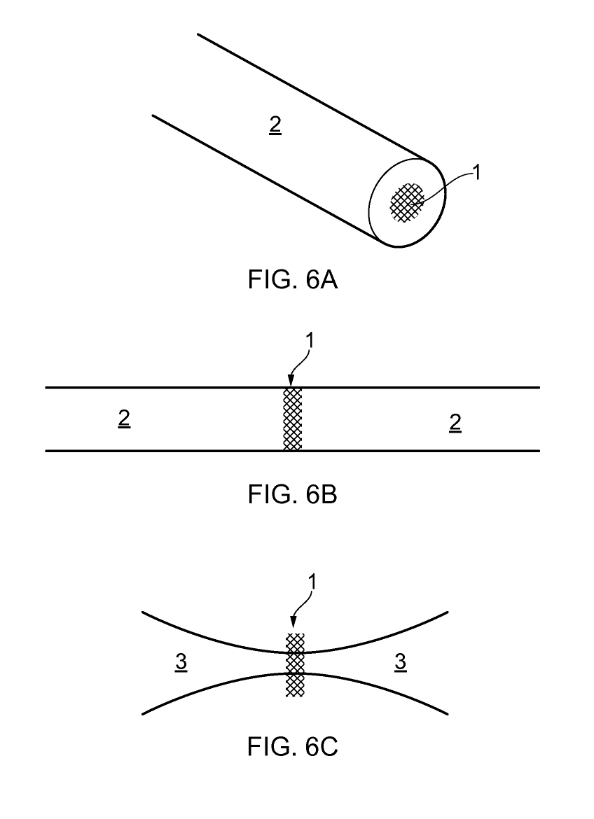

FIG. 6A is a perspective schematic drawing of an example optical limiter. An optical fiber 2 provides a waveguide for guiding light of a particular wavelength or range of wavelengths referred to as the operating wavelength or wavelength range. A non-linear element 1 is formed on an end face of the optical fiber 2. The coverage may be over the full area of the end face, or over a part thereof. For example, coverage could be limited to a central area of the end face corresponding to the core of the optical fiber. In other examples, it may also be important to cover a cladding area, e.g. for a cladding pumped optical fiber. The non-linear element 1 is made of a plasmonic metal material with a periodic structure having a period smaller than the operating wavelength. The plasmonic material has a non-linear process that is stimulated by light at the operating wavelength.

FIG. 6B is a schematic cross-section of another example optical limiter based on an optical fiber waveguide. The non-linear element 1 is placed within the optical fiber 2 extending transverse to the optical axis of the optical fiber. Such a device could be fabricated by taking the structure of FIG. 6A and fusing an additional portion of optical fiber onto the end face.

FIG. 6C is a schematic cross-section of a further example optical limiter based on a free space propagating optical beam 3. The optical beam 3 is focused and a non-linear element 1 is arranged at or near the beam waist. In an alternative design, the optical beam 3 may be collimated, i.e. not focused.

With the example metamaterial essentially constant output power has been observed for input power variations of ±25%.

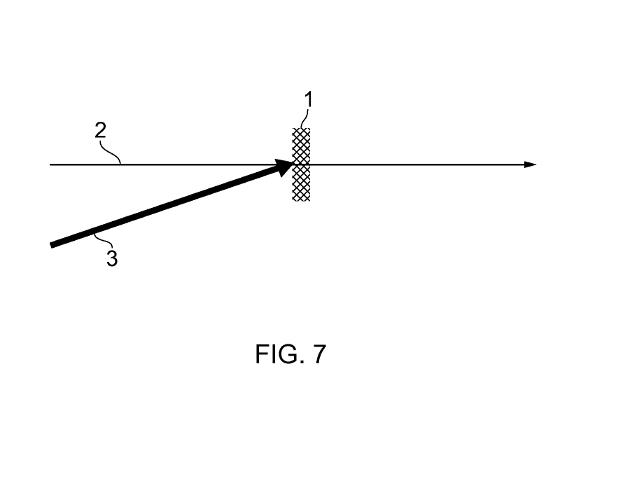

FIG. 7 is a schematic drawing of an example optical gating element which may be used as an optical transistor or optical data processing element. A non-linear element 1 made of a plasmonic metal material with a periodic structure to form a metamaterial. The non-linear element 1 is arranged in the path of a signal beam 2 which may be propagating in free space or within a waveguide. A control beam 3 is used to switch or gate the signal beam 2. Namely, the metamaterial 1 acts as an optical gate, where the transmission (and reflection) of the optical signal 2 is controlled by the control beam 3. For example, the control beam 3 can increase or decrease the transmitted signal. Both signal and control beam 2, 3 are overlapped on the metamaterial. Variation in the direction of the beams 2, 3 is possible. The signal and control beams 2, 3 can have the same or different (or multiple) center frequencies and bandwidths. Moreover, the signal beam may have multiple center frequencies, e.g. it may be a wavelength division multiplexed (WDM) signal.

With the example metamaterial, modulation depths of up to 57% have been observed with a response time of less than 100 fs.

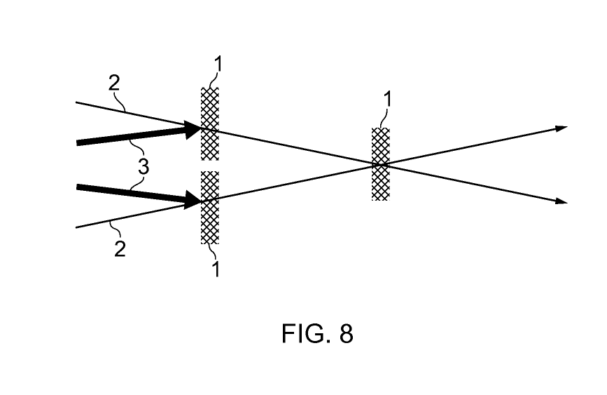

FIG. 8 is a schematic drawing of an example integration of multiple gating elements, for example for high density optical signal processing. The figure shows two metamaterial gates 1 actuated by respective control beams 3 as shown in FIG. 7 arranged in parallel to switch respective signal beams 2. The signal beam paths from these two gates coincided at a further non-linear element 1. As the non-linear response of the example metamaterial can be faster than 100 fs and its thickness can be much smaller than one wavelength, this allows the realization high density optical data processing systems operating at bit rates of more than 10 THz.

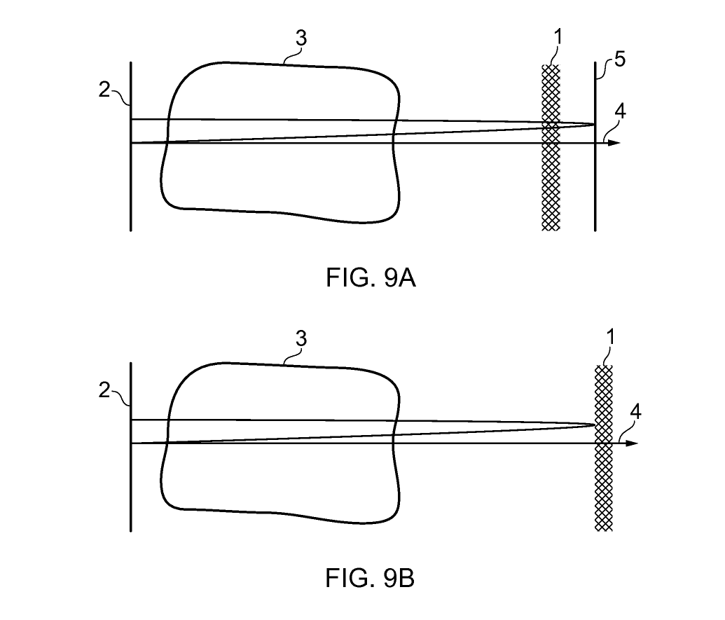

FIG. 9A is a schematic drawing of an example passive Q-switched or mode-locked laser. A laser cavity is formed by an end reflector mirror 2 and a partially transmissive output coupler mirror 5. A laser gain medium 3 and a metamaterial element 1 are arranged in the beam path 4 in the cavity. The metamaterial element 1 acts as a variable attenuator for Q-switching or mode-locking of pulsed laser operation.

FIG. 9B is a schematic drawing of another example passive Q-switched or mode-locked laser. This design is a variation of that of FIG. 9A in which the metamaterial element 1 also acts as the output coupler. In another design variation it could acts as the end reflector.

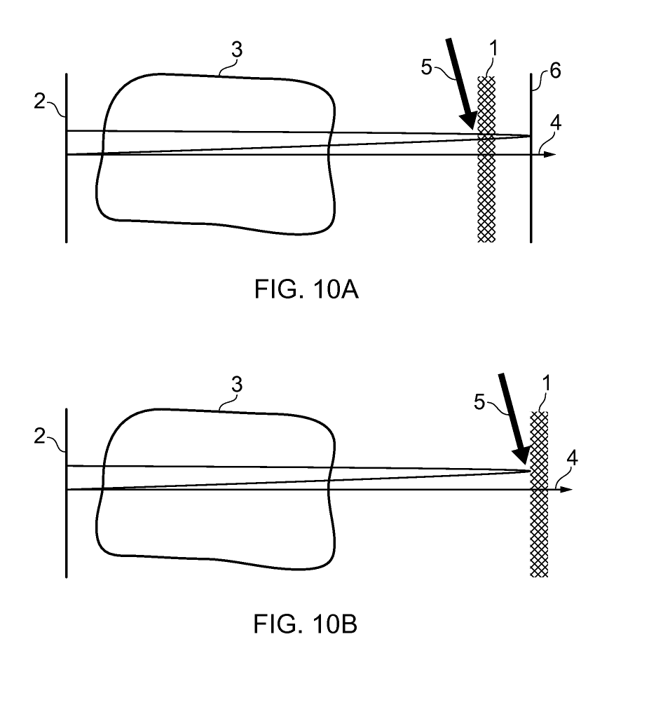

FIG. 10A is a schematic drawing of an example active Q-switched or mode-locked laser. The design is the same as that of FIG. 9A with the difference that the transmissivity of the metamaterial element 1 is controlled by a control beam 5 to provide active Q-switching or mode-locking.

FIG. 10B is a schematic drawing of another example active Q-switched or mode-locked laser. The design is the same as that of FIG. 9B with the difference that the transmissivity of the metamaterial element 1 is controlled by a control beam 5 to provide active Q-switching or mode-locking.

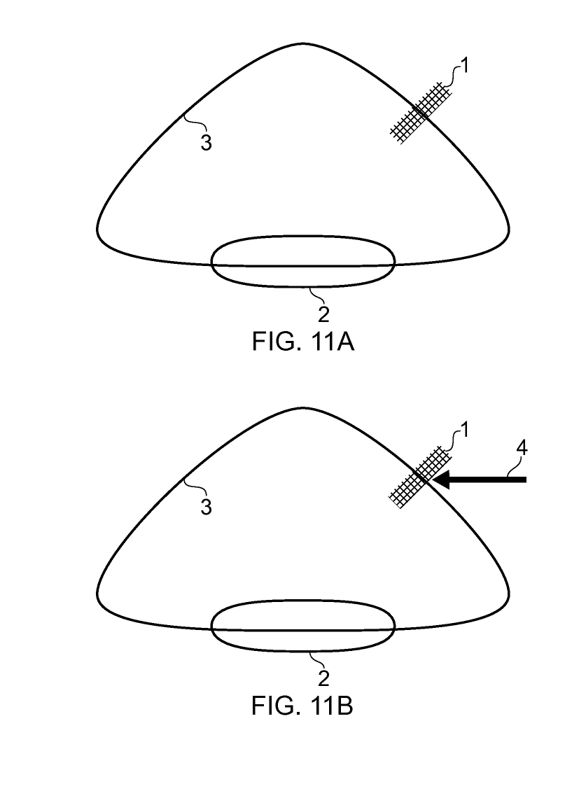

FIG. 11A is a schematic drawing of an example passive Q-switched or mode-locked ring laser. A ring cavity is formed by suitable mirrors or an optical fiber to form a closed loop beam path 3. The beam path includes a section of gain medium 2 and a metamaterial element 1, the latter acting as a variable attenuator for Q-switching or mode-locking. The transmission of the metamaterial element 1 is modulated by the beam itself in a passive mode of operation.

FIG. 11B is a schematic drawing of an example active Q-switched or mode-locked ring laser. The design is the same as that of FIG. 11A with the difference that the transmissivity of the metamaterial element 1 is controlled by a control beam 4 to provide active Q-switching or mode-locking.

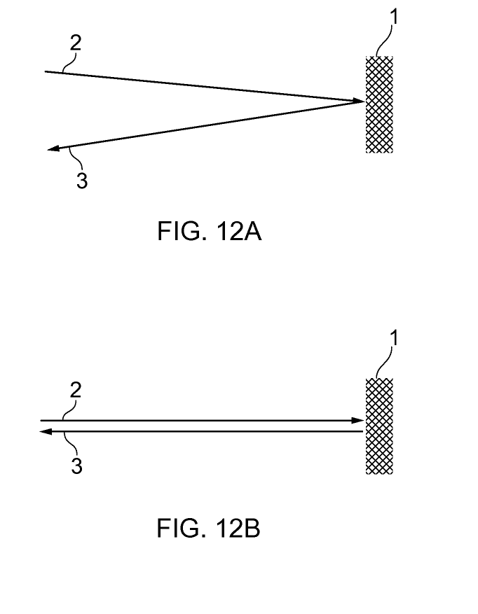

FIG. 12A is a schematic drawing of an example passive non-linear mirror with a non-normally incident beam. A metamaterial element 1 is provided to act as a non-linear mirror in respect of an incident light beam 2 which is reflected as reflected light beam 3. The reflection (and transmission) of an optical signal is controlled by the signal beam intensity itself, i.e. passive operation. The incident beam may be continuous or pulsed. For example, a higher intensity can increase or decrease the mirror's reflectivity. The angle of incidence of the signal beam and whether it is delivered by waveguides or as a freely propagating beam is not important.

FIG. 12B is a schematic drawing of an example passive non-linear mirror which is the same as FIG. 12A except for the normal angle of incidence of the incident beam 2 resulting in the reflected beam 3 sharing the same beam path as the incident beam.

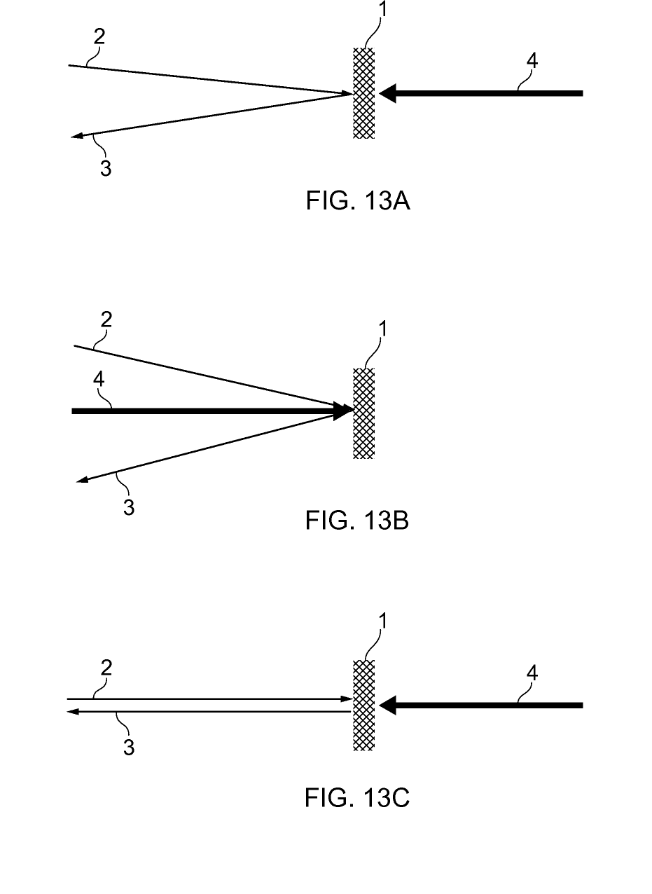

FIG. 13A is a schematic drawing of an example active non-linear mirror with a non-normally incident signal beam. A metamaterial element 1 acts as a non-linear mirror, where the reflection (and transmission) of an incident signal beam 2 to a reflected signal beam 3 is controlled by a control beam 4 which is incident on the metamaterial from the opposite side as the incident signal beam 2. For example, the control beam 4 can increase or decrease the intensity of the reflected signal 3. Both signal and control beam 2, 4 are overlapped on the metamaterial. The direction of these beams can be varied and they can be delivered by waveguides or as freely propagating beams. The signal and control beams 2, 4 can have the same or different (or multiple) center frequencies and bandwidths.

FIG. 13B is a schematic drawing of another example active non-linear mirror with a non-normally incident signal beam. This design is the same as that of FIG. 13A except that the control beam 4 is incident from the same side as the signal beam 2.

FIG. 13C is a schematic drawing of an example active non-linear mirror with a normally incident signal beam. This design is the same as that of FIG. 13A except that the incident signal beam 2 is incident normally to the mirror 1.

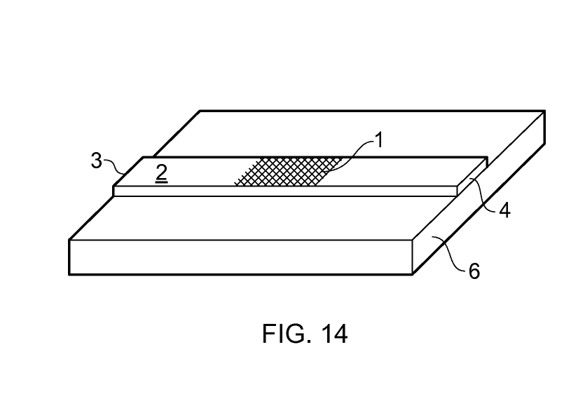

FIG. 14 is a schematic drawing of an example integration of a passive non-linear element embodying the invention in a planar waveguide. A rib waveguide 2 is arranged on a substrate 6. A non-linear element 1 made of the metamaterial is arranged on the upper surface of the waveguide 2. Alternatively it could be arranged inside the waveguide. A signal input beam 3 is modulated by the metamaterial element 1 to control the transmitted signal output beam 4. The metamaterial element 1 is controlled by the beam itself (passive case). This structure may form part of an optical limiter or a mode-locked or Q-switched laser, for example.

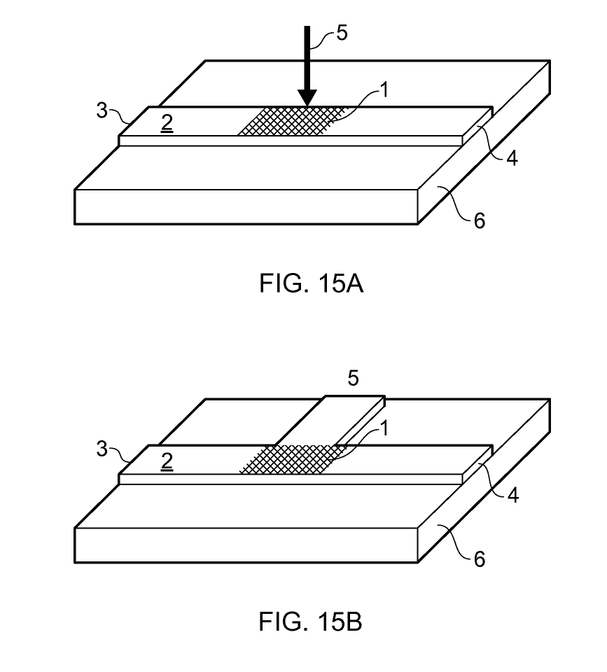

FIG. 15A is a schematic drawing of an example integration of an active non-linear element embodying the invention in a planar waveguide. This design is the same as that of FIG. 14 except that the metamaterial element 1 is actively switched by a control beam 5 which is applied as a free space propagating beam incident from above on the metamaterial 1 arranged on the upper surface of the waveguide 2.

FIG. 15B is a schematic drawing of another example integration of an active non-linear element embodying the invention in a planar waveguide. This design is the same as that of FIG. 15A except that the control beam 5 is delivered by another rib waveguide 5 which abuts the signal carrying rib waveguide 2 in a T-junction.

The structures of FIGS. 15A and 15B may form part of an optical gate or transistor for optical signal processing, or may be part of a mode-locked or Q-switched laser, for example.

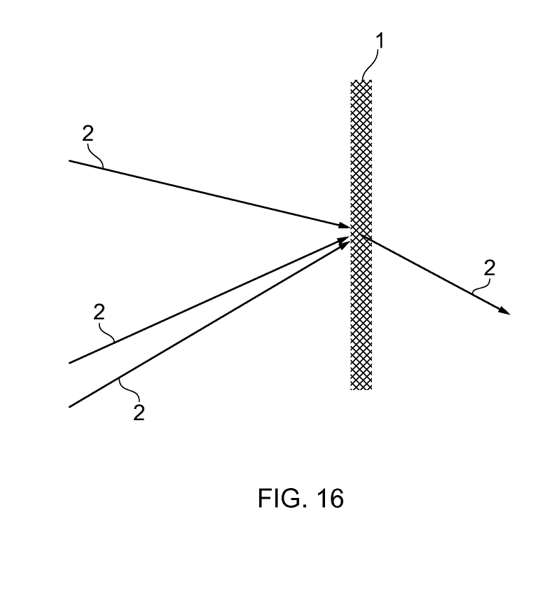

FIG. 16 is a schematic drawing of an example four-wave mixing device and phase-conjugated mirror. A metamaterial element 1 acts as a four-wave mixing device for mixing four freely propagating beams 2. Various combinations of propagation directions and frequencies of the four freely propagating beams are possible. Several of these beams can also have the same frequency and/or propagation direction and in particular two or more waves involved could co-propagate or counter-propagate along the same direction.

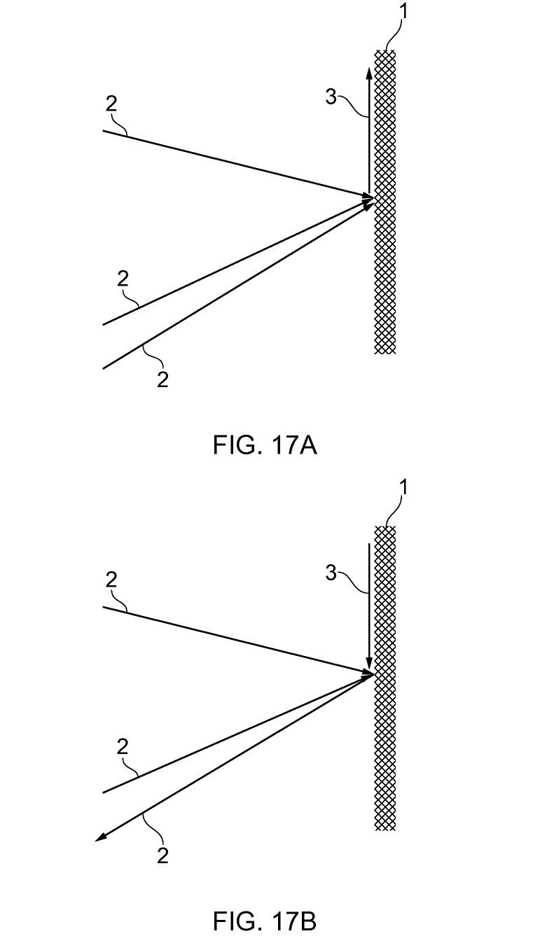

FIG. 17A is a schematic drawing of another example four-wave mixing device and phase-conjugated mirror which involves a surface plasmon wave 3 propagating on a metamaterial element 1 which acts as a four-wave mixing device for mixing three freely propagating incident beams 2 with the surface plasmon wave 3 which forms the output wave.

FIG. 17B is a schematic drawing of another example plasmonic four-wave mixing device and phase-conjugated mirror. The design is the same as that of FIG. 17A except that the plasmon wave 3 is an input wave. Several freely propagating beams 2 can have the same frequency and/or propagation direction and in particular two or more waves involved could co-propagate or counter-propagate along the same direction.

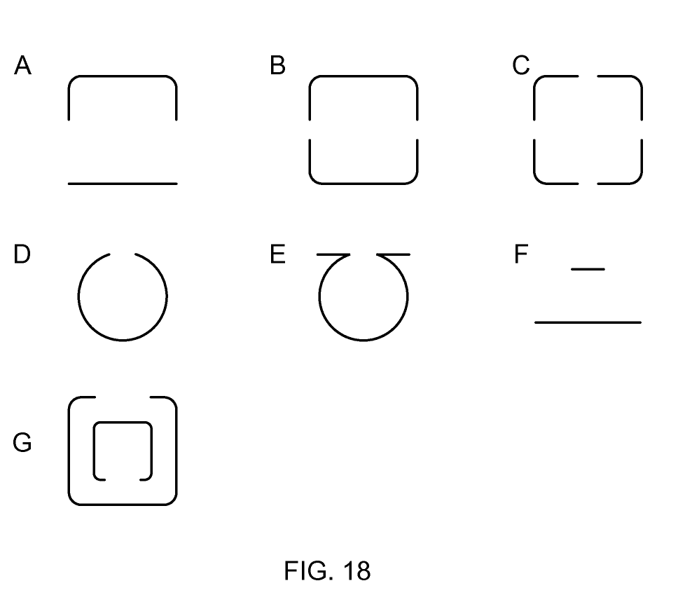

FIG. 18A-18G are schematic drawings of alternative unit cell forms for the metamaterial structure. FIG. 18A shows the structure used in the example, namely an asymmetric split ring in a plasmonic film. The same pattern could also be used in a “negative” version in which instead of slits in a plasmonic film the structure is made of wires of the plasmonic material arranged on a substrate. “Negative” wire versions of any of the following patterns 18B to 18G could also be provided as well as the “positive” slit versions. Generally the wire versions will require a substrate for support, whereas the slit versions can be implemented either on a supporting substrate or as self-supporting structures without a substrate.

FIGS. 18A-18G show the following alternative patterns:

A split square ring

B alternative split square ring

C further alternative split square ring made of four slits or wires

D circular split ring

E circular split ring with tails—omega shape

F parallel lines

G concentric split rings with splits angularly non-overlapping

The unit cells themselves may be arranged in a number of different kinds of arrays. The specific example shows a square array. A rectangular array could be used. Moreover, a hexagonal close-packed array could be used so that the unit cells of adjacent rows are offset.

Multiple layers of structured plasmonic material may also be provided to form 3D structures.

In a further development multiple arrays of different periods could be arranged on a single “chip”, i.e. a single non-linear element, so that a light beam incident on different ones of the multiple arrays would experience a different period meta-material. For example, the period could be incremented in discrete steps from one array to the next, and the chip could be moved relative to the incident beam or beams to select the desired array.

In a still further development, the properties of the metamaterial could be changed continuously across one or two dimensions of a chip. The continuously changed properties might include not only periodicity, but also plasmonic material composition in the case of an alloy and also unit cell size and unit cell geometry.

In summary, we have found that the third order optical non-linearity of metal films can be greatly enhanced and its sign controlled by metamaterial nanostructuring. Such films offer a variety of applications such as ultrafast optical limiters, saturable absorbers and terahertz bandwidth all-optical gates.

### REFERENCES

[1] D. Cho, et al. Optics Express 17, 17652 (2009).

[2] K. Dani, et al. Nano Letters 9, 3565 (2009).

[3] A. Nikolaenko, et al. Physical Review Letters 104, 153902 (2010).

[4] G. Wurtz, et al. Nature Nanotechnology 6, 107-111 (2011).

[5] E. Plum, et al. J. Opt. 13, 055102 (2011).

[6] M. Sheik-Bahae, et al. IEEE J. Quantum Elect. 26, 760 (1990).

[7] D. Smith, D. Vier, T. Koschny, and C. Soukoulis, Phys. Rev. E 71, 36617 (2005).

[8] R. Ganeev, et al. Opt. Commun. 231, 431 (2004).

What is claimed is:

1. A non-linear optical device comprising a non-linear element made of a plasmonic material, wherein the non-linear element has a range of operating wavelengths defined by the wavelength of a non-linear process intrinsic to the plasmonic material, and wherein the plasmonic material is structured with a period which is shorter than the operating wavelengths.

2. The device of claim 1, wherein the non-linear process is a direct multi-photon absorption process in the plasmonic material.

3. The device of claim 1, wherein the non-linear process is a saturable absorption in the non-linear element.

4. The device of claim 1, wherein the non-linear process is four-wave mixing in the non-linear element.

5. The device of claim 1, wherein the plasmonic material is a metal.

6. The device of claim 5, wherein the metal is gold, silver, aluminum, copper, or an alloy including one or more of these metals, or an alloy consisting of two or more of these metals.

7. The device of claim 1, wherein the non-linear element comprises a periodically structured layer of the plasmonic material.

8. The device of claim 7, wherein the periodically structured layer is self supporting.

9. The device of claim 7, wherein the periodically structured layer is supported by a substrate made of a material that has substantially negligible non-linearity in the operating wavelength range compared to the plasmonic material.

10. The device of claim 1, further comprising a waveguide having a waveguiding channel, and wherein the non-linear element is arranged integrally within or on the waveguiding channel.

11. A method of modulating an optical signal comprising making an optical beam of a particular wavelength incident on a non-linear element made of a plasmonic material that has a non-linear process active at that wavelength and which is periodically structured with a period which is shorter than the wavelength of the incident optical beam, so that the non-linear process modulates the incident optical beam.

12. A method of modulating a first optical signal with a second optical signal comprising making the first and second optical signals of respective first and second wavelengths co-incident as first and second optical beams on an area of a non-linear element made of a plasmonic material that has a non-linear process active at the first or second wavelengths, or a sum or difference of the first and second wavelengths, and which is periodically structured with a period which is shorter than the first and second wavelengths, so that the non-linear process modulates the first optical signal under action of the second optical signal.

13. A non-linear optical device comprising a non-linear element made of a plasmonic material with a periodic structure having a period shorter than the wavelength of a non-linear process intrinsic to the plasmonic material.
